(19) United States
(12) Patent Application Publication
(10) Pub. No.: US 2025/0148364 A1
(43) Pub. Date: May 8, 2025

(54) GENERATIVE ARTIFICIAL INTELLIGENCE FOR GENERATING RESPONSES BASED ON PREDICTED TRAJECTORIES

(71) Applicant: Google LLC, Mountain View, CA (US)

(72) Inventors: Joshua Brian Braverman, Oakland, CA (US); Camille Wormser, New York, NY (US); César Augusto Naranjo, San Diego, CA (US); Alexey Vaysburd, New York, NY (US); Dorothea Wiesmann Rothuizen, Oberrieden (CH); Brian Michael Burdick, Newcastle, WA (US); Jason Sean Krueger, Seattle, WA (US); Xiaoxuan Zhang, Jersey City, NJ (US); Sergiu Ion Goschin, New York, NY (US)

(21) Appl. No.: 18/815,781

(22) Filed: Aug. 26, 2024

Related U.S. Application Data
(60) Provisional application No. 63/596,557, filed on Nov. 6, 2023.

(51) Int. Cl. G06N 20/00

(52) U.S. Cl. CPC G06N 20/00

(57) ABSTRACT

Methods, systems, and apparatus, including computer programs encoded on a computer storage medium, for enabling artificial intelligence to display responses in a conversational user interface that are tailored to a user of the interface, to predicted future states, and/or to predicted trajectories that include transitions between multiple states. In one aspect, a method includes initiating a user session with a conversational user interface of an artificial intelligence system that displays, within the conversational user interface, responses to user interactions received during the user session, the responses being generated using one or more machine learning models of the artificial intelligence system. During the user session, the system receives data indicating one or more user interactions within the conversational user interface by a user. The system updates a state record that represents a first state. The system processes the state record to determine potential trajectories for the user session.

### CROSS-REFERENCE TO RELATED APPLICATION

This application claims priority to U.S. Provisional Application No. 63/596,557, filed on Nov. 6, 2023. The prior application is considered part of and is incorporated by reference in the disclosure of this application.

### BACKGROUND

This specification relates to data processing, artificial intelligence, and generating responses in artificial intelligence-based conversational user interfaces.

Advances in machine learning are enabling artificial intelligence to be implemented in more applications. For example, large language models have been implemented to allow for a conversational interaction with computers using natural language rather than a restricted set of prompts. This allows for a more natural interaction with the computer.

### SUMMARY

In general, one innovative aspect of the subject matter described in this specification can be embodied in methods that include the actions of initiating a user session with a conversational user interface of an artificial intelligence system that displays, within the conversational user interface, responses to user interactions received during the user session, the responses being generated using one or more machine learning models of the artificial intelligence system; during the user session: receiving, by the artificial intelligence system, data indicating one or more user interactions within the conversational user interface by a user; updating, by the artificial intelligence system, a state record that represents a first state, including data representing one or more substates, and wherein the one or more substates include a substate for the user, wherein the substate for the user is determined by the one or more machine learning models based on the one or more user interactions; processing, by the artificial intelligence system, the state record to determine one or more potential trajectories for the user session, wherein each potential trajectory represents a transition from the first state to a different state; obtaining, by the artificial intelligence system and for each of the one or more potential trajectories, a respective selection value for each of the states for the potential trajectory; and displaying, in the conversational user interface, one or more responses based at least in part on the selection values. Other implementations of this aspect include corresponding apparatus, systems, and computer programs, configured to perform the aspects of the methods, encoded on computer storage devices.

These and other embodiments can each optionally include one or more of the following features. In some aspects, the one or more user interactions include user queries provided by the user.

In some aspects, the substate for the user is further based on any one or more of information related to one or more previous user sessions for the user with the artificial intelligence system, or contextual information about the user.

In some aspects, the state record further includes any one or more of data representing a substate of a digital component provider, or data representing a substate of a distribution plan. Some aspects include receiving, by the artificial intelligence system, data indicating one or more changes to the substate of the digital component provider or to the substate of the distribution plan and updating, by the artificial intelligence system, the state record based on the data indicating one or more changes.

In some aspects, the state record further includes data representing a substate determined based on present contextual information related to an environment in which the user session is occurring.

Some aspects include receiving, by the artificial intelligence system, data indicating one or more changes to the substate determined based on present contextual information and updating, by the artificial intelligence system, the state record based on the data indicating one or more changes.

In some aspects, the state record is maintained across multiple user sessions for the user and the state record is updated during each user session of the multiple user sessions.

In some aspects, processing the state record to determine one or more potential trajectories for the user session includes including the state record in one or more inputs to one or more machine learning models and receiving one or more potential trajectories from one or more machine learning models.

In some aspects, a potential trajectory of the one or more potential trajectories includes, for one or more states, one or more substate changes.

In some aspects, a potential trajectory of the one or more potential trajectories includes, for one or more states, one or more actions. The one or more actions can include any one or more of a user interaction within the conversational user interface, a user interaction with a resource of a digital component provider, or a potential response displayed within the conversational user interface.

In some aspects, a potential trajectory of the one or more potential trajectories includes one or more intermediate states.

In some aspects, each potential trajectory of the one or more potential trajectories includes a utility and a likelihood for one or more of the states. The different state can be a goal state, and each potential trajectory of the one or more potential trajectories includes a utility and a likelihood for one or more of the states.

In some aspects, data representing the goal state is included as an input prompt to the one or more machine learning models so that the one or more machine learning models generate potential responses that are associated with the goal state.

In some aspects, obtaining a respective selection value for each of the states includes obtaining a respective selection value for each of the states in each potential trajectory from each of multiple digital component providers. Displaying one or more responses based at least in part on the selection values can include selecting a state that has a highest selection value, obtaining a potential response associated with the selected state, and displaying the potential response in the conversational user interface. Displaying one or more responses based at least in part on the selection values can include selecting a potential trajectory that has a highest combination of selection values for the states of the potential trajectory, obtaining a potential response associated with a first state of the selected potential trajectory, and displaying the potential response in the conversational user interface.

Some aspects include, after displaying one or more responses, receiving, for each response, data indicating one or more user interactions by the user and updating the state record based on the one or more user interactions for each response.

In some aspects, the one or more responses include one or more digital components.

Particular embodiments of the subject matter described in this specification can be implemented so as to realize one or more of the following advantages. The techniques described in this specification allow for an artificial intelligence system to predict the utility and likelihood of future states and/or trajectories between states, and to select relevant content that is associated with a desired future state based on the predictions. A state can include a combination of substates including a user substate that represents the state of the user, a digital component substate that represents the state of a digital component provider for a digital component group that includes one or more digital components for an item, and/or a market substate that represents the state of a market for the item and/or an overall market. In addition, digital component providers can influence responses presented in a conversational user interface and/or user actions (e.g., that can lead to transitions between states) based on the current state and/or predicted future state(s). For example, the system described in this specification can receive data indicating one or more user interactions within the conversational user interface by a user. The system can update a state record that includes data representing a user substate for the user. The system can process the state record to determine (e.g., predict) the utility and likelihood of future states for a digital component group. A trajectory can represent a transition from a first state to a different state. Each trajectory can include one or more intermediate states. Each state, such as an intermediate state or a different state, can be associated with an action or a change in a substate of the state. The system can obtain selection values for one or more of the states in the potential trajectories from digital component providers that provide digital components. The selection value for a state for a digital component group can be based on an expected utility and likelihood for the digital component group given the state. The system can perform an action such as selecting and displaying a response associated with the state in the conversational user interface based on the selection values. The response can include a digital component of a digital component group selected based on the selection values. The system can thus display a response to the user based on the selection values provided by the digital component providers.

The described techniques provide for a tailored user experience. For example, the actions in each potential trajectory can be potential responses that are likely to lead to a goal state. With each user interaction that the system receives, the system can update the state record, predicted intermediate states, and the potential actions in the potential trajectories. The responses that are displayed are thus based on the user interactions of the user session.

As described in more detail below, a digital component substate can include a distribution plan substate that represents the state of a distribution plan for a digital component group of the digital component provider. In such examples, the responses that are displayed can also be based on a distribution plan substate. For example, with each update of the distribution plan that the system receives, the system can update the state record, predicted intermediate states, and the potential actions in the potential trajectories. The responses that are displayed can thus differ depending on the current distribution substate. Similar updates to the market substate can also result in different responses being displayed.

The techniques can provide for a customized user experience over an extended period of time. For example, the system can update the state record based on user interactions in a current user session for a user. The system can also update the state record based on user interactions from previous user sessions for the user, and contextual information about the user. For example, the state record can be maintained and updated across multiple user sessions for the user. The use of information that has been refined over multiple user sessions increases the accuracy of the responses (e.g., selected digital components, conversational responses, etc.) of the artificial intelligence system by adapting to the user's goals or interests.

Using artificial intelligence to determine potential trajectories and provide responses based on data representing a user substate for the user enables the system to provide more relevant information to the user, which gets the user to the information that the user is seeking faster, which results in fewer queries by the user, fewer responses to such queries, and reduces the number of web pages and/or other resources to which the user has to navigate to find relevant information. All of these things reduce the computational burden placed on computing resources to transmit the queries over a network, analyze the queries to generate responses, and transmit resources over the network, which also reduces the amount of consumed bandwidth of the network and battery power of mobile devices of users submitting the queries. This also reduces the number of inputs that need to be provided by a user, resulting in less time that the display of mobile devices are illuminated, which provides additional battery savings and further enhances power management of mobile devices.

For example, a response can include an image or video digital component that has a relatively large data size. Absent the described techniques, a system can provide such digital components in response to each query based on limited information. By predicting and/or influencing the users' trajectory, the system can reduce the number of queries required to select a digital component having relative content for the user, which reduces the number of images and/or videos sent to the user's device, resulting in the resource savings described above.

Predicting and/or influencing the trajectories of users can also lead to the provision of relevant information to users faster and with fewer user interactions with the system. For example, predicting that the intent of a user is to download a mobile application that performs a particular function and providing information about one or more applications that performs the particular function early in the conversation or search session can result in fewer queries and reduce the computational burden placed on computing resources in a similar manner as the techniques described above.

Using artificial intelligence to recommend actions, e.g., to recommend selection values for digital components or digital component groups, based on the likelihood and utility of states being reached can reduce the number of digital components that are transmitted to the devices of users and displayed by the devices. For example, the knowledge that a high utility state has a high likelihood of being reached after multiple transitions along multiple states can result in the system waiting to display a digital component until closer to that state and precluding the display of another digital component that is not likely to result in a desired action.

The described techniques provide particular ways of using artificial intelligence to select and/or customize content for users. For example, the described techniques provide a specific application of artificial intelligence models to user data to predict trajectories of users and select content for the users based on the trajectories. As described above, this results in a more efficient way of selecting and/or customizing content for the user.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which responses are generated and displayed in a conversational user interface based on a state record.

FIG. 2 is a block diagram illustrating interactions between an artificial intelligence system and a client device.

FIG. 3 depicts example potential trajectories.

FIG. 4 is a flow chart of an example process for generating and displaying responses in a conversational user interface based on a state record.

FIG. 5 is a block diagram of an example computer.

Like reference numbers and designations in the various drawings indicate like elements.

### DETAILED DESCRIPTION

This specification describes techniques for enabling artificial intelligence to display responses in a conversational user interface that are tailored to a user of the conversational user interface, to predicted future states, and/or to predicted trajectories that include transitions between multiple states. Artificial intelligence (AI) is a segment of computer science that focuses on the creation of intelligent agents that can learn and act autonomously (e.g., without human intervention). Artificial intelligence can utilize machine learning, which focuses on developing algorithms that can learn from data, natural language processing, which focuses on understanding and generating human language, and/or computer vision, which is a field that focuses on understanding and interpreting images and videos.

The techniques described throughout this specification enable AI to display responses that are tailored to a user of the conversational user interface, to predicted future states, and/or to predicted trajectories that include transitions between multiple states. Each state can be based on different substates such as a user substate for the user of the conversational user interface, a substate for a digital component provider (which can include a distribution plan substate), and/or a market substate. In some implementations, the user substate can be determined (e.g., predicted or inferred) based on the user's interactions with the conversational user interface, or with a search engine user interface associated with the conversational user interface. In some implementations, the user substate can be determined (e.g., predicted or inferred) based on the user's interactions with the conversational user interface and with the search engine user interface related to the conversational user interface. The user substate can represent a user's intent at the corresponding state that includes the user substate. For example, user substates can include seeking information, exploring options, or purchasing an item.

A digital component provider substate can represent the state of a digital component provider for the corresponding state. The digital component substate can be based on the strategy for distributing digital components in a digital component group to users and/or a distribution plan for the digital component group, which can be represented by its own distribution plan substate. The distribution plan can include, for example, a rate at which the digital components in the digital component group should be distributed over a time period, an amount of resources (e.g., budget) that can be used to distribute the digital components, and/or distribution parameters for the digital components. The distribution plan substate of a current state can include a current rate at which the digital components are being distributed and/or a current amount of resources remaining for the time period. The distribution plan substate for a future state can include a predicted rate at which the digital components will be distributed at that future time and/or a predicted amount of resources remaining at that future time.

The market substate can represent a state of a market for an item that is the subject of the digital component(s) in the digital component group and/or an overall market. For example, some items may be sold at higher rates during certain periods of time and the market substate can represent the demand for the item during the time of the corresponding state. In another example, the market substate can represent time periods (e.g., weekends vs. weekdays, holidays, etc.) and the demand for the item corresponding to the time periods. The market substate can represent trends for the item, its category, and/or the overall market. For example, the market substate can represent whether the item is part of a recent fad, the state of the global supply chain for the item or components of the item, and the maturity level of the item (e.g., new or established).

In some implementations, an AI system can display a response that includes content related to a corresponding item from a digital component provider based on queries provided in the conversational user interface by the user. The AI system can process user interaction events by the user in reply to the response, such as a query or a user interaction event indicative of whether the user interacted with the response. The AI system can update a state record based on the user interactions (and any information that can be used to update the digital provider substate and/or market substate), and display additional responses based on the data of the state record.

Generally speaking, the system can utilize an input prompt to a language model, such as a large language model (LLM), or another type of machine learning model that outputs multiple clauses to update the state record. The system uses the clauses to update the data representing a state.

The system can also utilize an input prompt to a language model, e.g., an LLM, that outputs multiple clauses to determine one or more potential trajectories. The system uses the clauses to determine potential future states and potential responses that may to the potential future states. The system then selects one or more potential responses to display to the user in the conversational user interface.

Each state record can be associated with a user. The state record can include data representing a current user substate for the user. The current user substate for the user can include contextual information about the user and information about previous interactions of the user with the artificial intelligence system. The user substate for the user can be updated during the user session as the user substate for the user changes, e.g., throughout the user session as new interactions occur, as new responses are provided to the user.

The state record can also include data for other substates, e.g., the digital component provider substate and/or the market substate described above. For example, the state record can include the data related to these substates described above. The state record can also include data representing a substate determined based on present contextual information related to an environment in which the user session is occurring.

In some implementations, the state record can also be stored by the AI system and maintained across user sessions for the same user. The AI system can maintain a separate state record for multiple users. For example, the AI system can maintain a state record for each user.

In some implementations, the AI system can utilize an input prompt to a language model or use another type of machine learning model, e.g., another type of neural network trained using reinforcement learning, to determine selection values for digital components. For example, the state record can be provided as input to a machine learning model trained to output a selection value for a digital component group based on predicted trajectories and, for each state of each predicted trajectory, a likelihood for the state and a utility of the state with respect to the digital component group. The machine learning model can predict trajectories and their states, predict the likelihood that the state will occur for the user, and predict a utility of the user reaching the state. In a particular example, a trajectory can proceed through states that include, as user substates, substates of discovery, analysis, and purchase. The purchase substate can have significant utility (e.g., the user purchases an item that is the subject of the digital component(s) in the digital component group).

In some implementations, the AI system can use the machine learning model to generate selection values for multiple digital component groups for multiple different items, e.g., of multiple different digital component providers. In this example, the AI system 160 can generate trajectories and their states for each digital component group and use this information to determine the selection values. In this way, the AI system can generate the selection values and potentially influence the user's actions based on the likelihood and utility of the various states. For example, in some cases it may be better to show a first digital component that is less likely to result in a desired user action instead of a second digital component that is more likely to result in the desired user action if the state at which the desired user action is a few states away and the distribution plan substate indicates that the resources for the second digital component will be low when that state is likely to occur. Thus, the AI system can use the likelihoods and utilities, along with the state information, to generate selection values that provide the most utility.

As discussed in more detail below, the prompts described herein are specialized (e.g., created or augmented) to improve the overall relevance to the user's needs or interests of the responses that are displayed. For example, the prompt can include the data of a state record, e.g., data representing a user substate, data representing a digital component provider substate, and/or data representing a market substate.

Using specialized prompts described herein reduces wasted computing resources that would otherwise generate less relevant trajectories and potential responses if more general prompts were used. Thus, the system can avoid the creation and display of responses that the user is not likely to show interest in, which reduces the time and computing resources required to generate and display the responses. The system can also provide the user with responses the user is more likely to interact with, creating a more efficient user experience, and reducing the time and computing resources of the conversational user interface.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

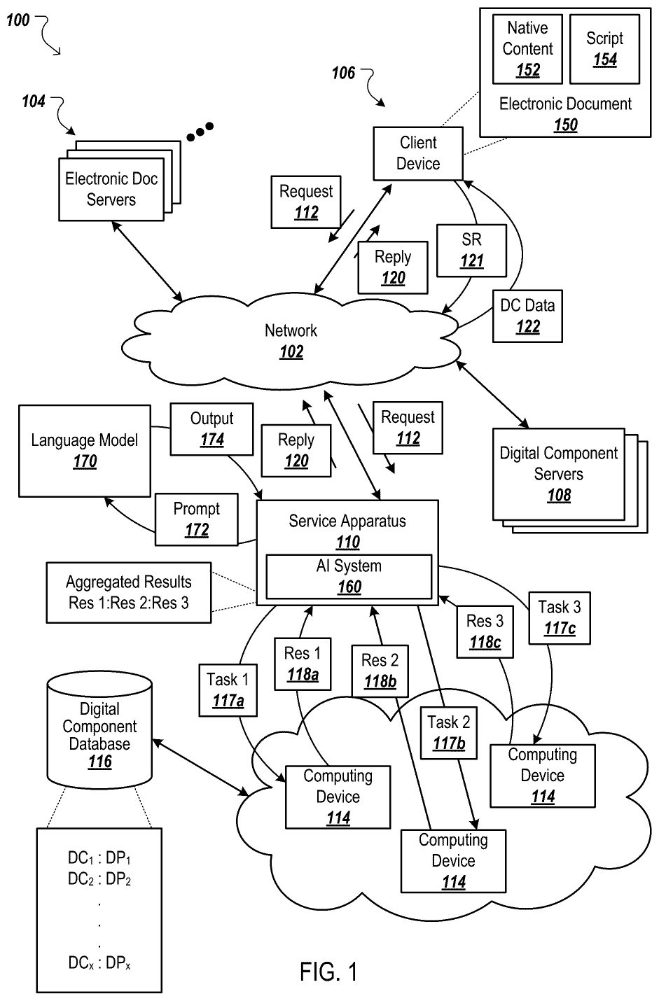

FIG. 1 is a block diagram of an example environment 100 in which generative artificial intelligence can be implemented. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, user devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

For example, the user interface can be a conversational user interface. A conversational user interface can be configured to allow one or more users of the client device 106 to communicate with other components of the environment 100 through natural language text, which can include text input by the user or text recognized from audio or video input. For example, the conversational user interface can be configured to allow a user to provide user queries. The conversational user interface can display responses to user queries. The response can include a conversational response such as a natural language text relevant to a user query, for example. The response can also include, for example, a digital component. In some examples, the response can include natural language text relevant to a user query and a digital component. The responses can be generated by other components of the environment 100 such as a language model 170. The conversational user interface can also be configured to allow a user to interact with responses that are displayed. For example, a user can respond to a response with another user query, or select (e.g., click on the response), hover over the response, pin the response to a user repository, save the response, remove the response, etc. A hover can include a user placing a cursor or other pointer over the digital component, e.g., for at least a threshold period of time.

As another example, the user interface can be a search engine user interface. A search engine user interface can be configured to allow one or more users of the client device 106 to communicate with other components of the environment 100 through text, which can include text input by the user or text recognized from audio or video input. For example, the search engine user interface can be configured to allow a user to provide user queries. The search engine user interface can display responses to user queries. The response can include a link to an electronic document relevant to a user query, for example. The responses can be generated by other components of the environment 100 such as a search system or search engine. The search engine user interface can also be configured to allow a user to interact with responses that are displayed. For example, a user can hover over the response or click on the response. A hover can include a user placing a cursor or other pointer over the digital component, e.g., for at least a threshold period of time.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which the digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital components in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an AI system 160 configured to autonomously generate digital components, either prior to a request 112 (e.g., offline) and/or in response to a request 112 (e.g., online or real-time). As described in more detail throughout this specification, the AI system 160 can collect online content about a specific entity (e.g., digital component provider or another entity) and summarize the collected online content using one or more language models 170, which can include large language models.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code.

A language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution, e.g., a probability distribution, that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

Note that, although the operations of the AI system 160 and language model 170 are described above as being performed responsive to receipt of the request 112, at least some of the operations can be performed prior to receipt of the request 112.

In some implementations, the AI system 160 can generate a prompt 172 that is submitted to the one or more language models 170, and causes the one or more language models 170 to generate the output sequences 174, also referred to simply as “output”. The AI system 160 can generate the prompt in a manner (e.g., having a structure) that includes, for example, the data of a state record. In some implementations, to initiate creation of the output sequences 174, the AI system 160 submits the prompt 172 to the one or more language models 170, which evaluate the information specified in the prompt 172, and generate the output 174 that includes one or more potential trajectories for the user session based on the data of the state record specified in the prompt 172.

The state record can represent a predicted current user substate for the user. For example, each substate can represent a predicted current intent for the user. The substate for the user can represent, for example, one or more user interactions within the conversational user interface. The substate for the user can also represent information related to one or more previous user sessions of the user with the AI system 160. The substate for the user can also represent contextual information about the user. For example, the contextual information can include information about the user, the user session, or of a particular user interaction. Other contextual information can include, for example, a location of the client device 106 during the user session, or a time of day and a time of year of the user session or of a particular user interaction.

The state record can also represent a predicted current digital component provider substate of each of one or more digital component providers that make digital components available to the service apparatus 110 for distribution to client devices 106. The state record can also represent a current distribution plan substate for the digital component provider. For example, the digital component provider substate of the digital component provider can indicate information about the inventory of products or the goals of the digital component provider. The substate of the distribution plan for a digital component provider can indicate information about the current available distribution resources, or the total available amount the digital component provider has for a digital component over a given time period.

The state record can also represent a substate determined based on present contextual information related to an environment in which the user session is occurring. For example, the present contextual information can indicate information about the availability of products or trends. The state record can also represent a market substrate that defines the current market for an item that is the subject of a digital component and/or the overall market.

Furthermore, although a single language model 170 is shown in FIG. 1, different language models can be specially trained to process different prompts at different stages of the user session. For example, a more general (e.g., larger) language model can be used to generate a state record at the beginning of a first user session, or to update an existing state record at the beginning of each user session. In another example, the larger language model can be used to update the state record at other points in time, e.g., during the user session. For example, the state record can be updated in a parallel process while the state record is not being used or while an older version of the state record is being used to generate responses. In this way, the state record can be more accurately updated without inducing latency into the system. In some implementations, the data of the updated state record can be included in prompts that are input to more specialized and faster language models that are trained to be provide potential trajectories in milliseconds such that they can be used to select responses in real time without slowing the selection process or causing errors in loading content at the client devices.

As an example, the AI system 160 can include separate language models. For example, the AI system 160 can include a language model for generating or updating state records. In some implementations, the AI system can include a language model for determining (e.g., predicting) potential trajectories. In some implementations, the same language model can be configured to generate or update state records and determine potential trajectories. The AI system 160 can also store the data of state records of multiple users.

In some implementations, one or more machine learning models such as the language models of the AI system 160 can be a simplified version of a more complicated machine learning model. For example, the simplified version can be a policy network or a model that has been trained through teacher-student learning or another distillation technique.

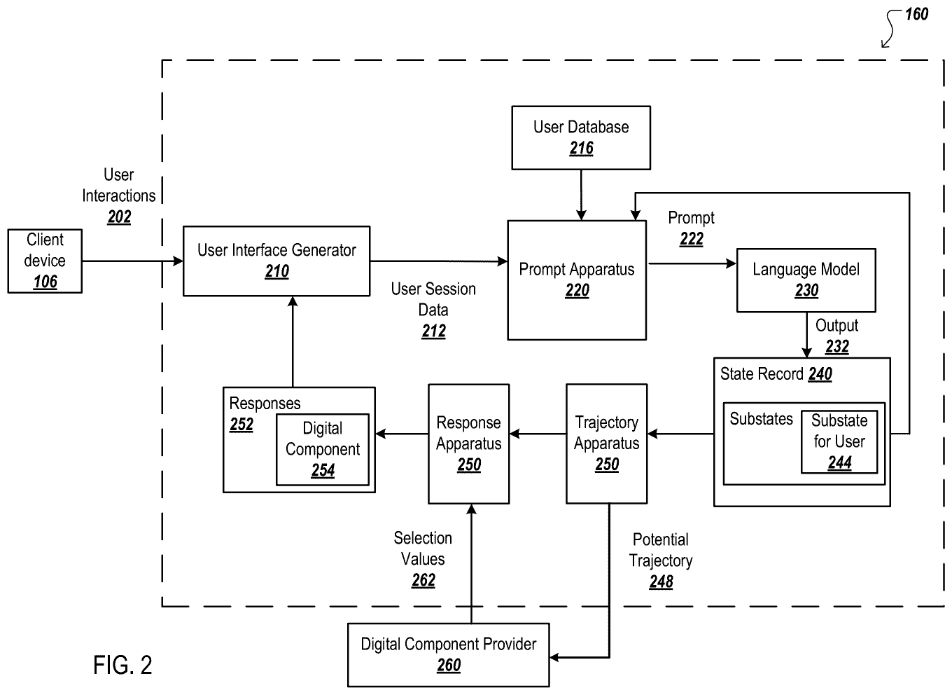

FIG. 2 is a block diagram 200 illustrating interactions between an AI system 160 and a client device 106. The AI system 160 can include a user interface generator 210, a prompt apparatus 220, a user database 216, a language model 230, a state record 240, a trajectory apparatus 250, and a response apparatus 270. Although the diagram 200 shows one state record 240, the AI system 160 can include multiple state records. For example, the AI system 160 can include a state record for each user, or multiple state records for each user.

A user of the client device 106 can interact with the AI system 160 through a conversational user interface on the client device 106. For example, the conversational user interface can be displayed on the client device 106. During a user session, the user can interact with contents of the conversational user interface by speaking, typing, or using a pointer, for example.

A user session may begin when a user navigates to the conversational user interface. For example, a user can navigate to the web page of the conversational user interface, or open an application that includes the conversational user interface. A user session may also begin upon a user's first interaction with the conversational user interface, or upon a first query input by the user. A user session may end when a user navigates away from the conversational user interface. For example, the user can leave the web page of the conversational user interface, or close the application that includes the conversational user interface. A user session may also end when there have been no interactions with the conversational user interface for a specified duration of time.

A user of the client device 106 can also interact with the AI system 160 through a search engine user interface on the client device 106. For example, the search engine user interface can be displayed on the client device 106. During a user session, the user can interact with contents of the search engine user interface by speaking, typing, or using a pointer, for example.

In some implementations, a user session may begin when a user navigates to the search engine user interface. For example, a user can navigate to the web page of the search engine user interface, or open an application that includes the search engine user interface. A user session may also begin upon a user's first interaction with the search engine user interface, or upon a first query input by the user. A user session may end when a user navigates away from the search engine user interface. For example, the user can leave the web page of the search engine user interface, or close the application that includes the search engine user interface. A user session may also end when there have been no interactions with the search engine user interface for a specified duration of time.

The conversational user interface can be configured to allow a user to provide user interactions 202. For example, the conversational user interface can allow a user to type a user query of natural language text. The conversational user interface can also display responses 252 to user interactions 202. A response 252 can include, for example, natural language text that is relevant to the user interaction 202, and/or a digital component 254.

The conversational user interface can also allow a user to interact with responses 252. For example, a user can respond to a response 252 with another user query 202. A user can also interact with the response 252 using a pointer. Other examples of user interactions can include when the user clicks on content of the response, hovers over content of the response, pins content of the response, saves content of the response, or performs other actions with content of the response. Other examples include viewing or watching content of the response, for example, if the content of the response includes a video. For example, if the user interaction indicates that the user watched a video of the response for two minutes, the data representing the user interaction can include data indicating a view time of two minutes for the video.

The conversational user interface can detect user interactions with responses 252, or for content of responses 252. For example, the response 252 can include a digital component 254 that includes content related to a corresponding item. Data representing a user interaction can indicate whether a user interacted with a displayed digital component 254 while the digital component 254 was displayed in the conversational user interface. Data representing a user interaction can also indicate the type of the user interaction and/or the duration of the user interaction. If the user selected the digital component, which caused the client device 106 to navigate to an electronic document, the data representing the user interaction can indicate a duration of time that the user spent at the electronic document. For example, if selection of the digital component caused the client device 106 to display a web page linked to by the digital component and the user viewed the web page for two minutes, the data representing the user interaction can include data indicating a view time of two minutes for the user selection of the digital component.

The conversational user interface can be updated by the AI system 160. For example, the AI system 160 can use the user interface generator 210 to generate and update user interfaces that are displayed at the client device 106. For example, the user interface generator 210 can update the conversational user interface. The user interface generator 210 can receive a response 252 generated by the AI system 160. The user interface generator 210 can update the user interface that is displayed at the client device 106 to include the response 252. In some examples, the response 252 can include a digital component 254. The user interface generator 210 can update the user interface to display the content of the digital component 254, such as a link, image, and/or description. In some examples, the response 252 can include natural language text. The user interface generator 210 can update the user interface to display the natural language text.

The user interface generator 210 can also receive updates from the user through the conversational user interface. That is, the user interface generator 210 can receive user interactions 202 such as user queries through the conversational user interface.

The AI system 160 can provide data indicating the user interactions 202 as user session data 212 to the prompt apparatus 220. The prompt apparatus 220 can be configured to generate a prompt 222 for the language model 230 that includes user session data 212. For example, during a user session, the user session data 212 can include at least some or all of the user interactions 202 for the user session. For example, the user session data 212 can include the user interactions for a window of time during the user session. The prompt 222 can thus include data representing the user interactions 202. In some implementations, the prompt apparatus 220 can generate the prompt 222 to include other data about the user, such as information related to user session data from previous user sessions, or data representing other information about the user. Other information can include, for example, a location of the client device, a type of client device, a time of day, a month of year, etc. For example, the prompt apparatus 220 can obtain previous user session data or data representing other information about the user from the user database 216. Other information can include places of interest for the user, or previous purchases by the user, for example.

In some implementations, the user session data 212 can include at least some or all user interactions for a user session with a search engine user interface associated with the conversational user interface. For example, the user session data 212 can include user queries to the search engine user interface, and/or user interactions with responses displayed in the search engine user interface.

In some implementations, the AI system 160 can provide other information to the prompt apparatus 220. For example, the AI system 160 can obtain data representing information about a digital component provider 260. The information can include inventory information, or a distribution plan, for example. Inventory information can include a number of available items corresponding to a digital component, and a location of the available items. The distribution plan can include a total amount of resources the digital component provider has for a digital component group over a given time period and/or a rate at which the digital component(s) in the digital component group should be distributed over the given time period.

The AI system 160 can also provide information such as contextual information related to an environment in which the user session is occurring. For example, the contextual information can include supply chain information such as transportation routes and weather patterns, the time of year, the date, the day of the week, product trends (e.g., whether the demand is unusually high representing a fad or low), and product maturity.

The prompt apparatus 220 can thus generate a prompt 222 that includes user session data 212, data representing information about a digital component provider 260, and contextual information related to the environment in which the user session is occurring.

In some implementations, the AI system 160 can run at least the prompt apparatus 220 and the language model 230 in a secure and/or isolated environment to protect user privacy. For example, the AI system 160 can include a Trusted Execution Environment (TEE) in which the language model 230 is executed. A TEE can manage the data that is provided to and sent from the TEE. This can prevent sensitive user data that is used by the language model 230 from being accessible outside of this secure environment.

In some implementations, the prompt apparatus 220 can generate an embedding of data, and provide the embedded data as part of the prompt 222. For example, the prompt 222 can include different types of data such as text, images, and/or video. As an example, the prompt 222 can include an embedding of previous digital components that were displayed to the user and previous digital components that were interacted with by the user.

In some examples, the prompt apparatus 220 can include the data of the state record 240 for the user in the prompt 222. For example, for a user that has an existing state record 240 (which can include data across multiple user sessions of the user), or existing state record 240 for the user session, the prompt apparatus 220 can include the data of the state record 240 in the prompt 222. In some implementations, the prompt apparatus 220 can embed the data of the state record 240 for inclusion in the prompt 222, or constrain the size of the prompt 222.

Thus, the prompt 222 can include any combination of user session data 212, data representing information about a digital component provider 260, contextual information related to the environment in which the user session is occurring, and data of the state record 240 for the user.

The AI system 160 can provide the prompt 222 to the language model 230. The language model 230 can include the one or more language models 170 described above with reference to FIG. 1. The language model 230 can generate an output 232 based on the prompt 222.

In some examples, the language model 230 can be trained to output updates to a state record 240 based on the prompt 222. The prompt 222 can include, for example, user interactions 202, and/or an existing state record 240. The language model 230 can process the prompt 222 to generate an output 232 that includes an update to the state record 240. The output 232 can also be a state record 240, for example, for a first user session of a user, or upon receiving a first query in a current user session, if the AI system 160 does not have an existing state record 240 for the user.

In some implementations, the AI system 160 can use the language model 230 to invoke another program, such as an application programming interface (API). For example, the AI system 160 can provide a path or location of a state record 240 as part of the prompt 222 and use the language model 230 to invoke another program to access the data of the state record 240.

The state record 240 can represent multiple substates. For example, the state record 240 can include data representing a user substate for the user 244. For example, the user substate for the user 244 can include a prediction about the user's intent. In some implementations, the user substate for the user 244 can include information about the user's interests. For example, the user substate for the user 244 can include a prediction of what the user is trying to accomplish based on the information about the user interactions. The user substate for the user 244 can be determined based on the user's interactions in the current user session, for example. The language model 230 can determine the user substate for the user 244 based on the user interactions. For example, a selection or click on a response can indicate a higher level of user interest in the content of the response than a hover over the response. As another example, a longer duration spent on an electronic document linked to by a response can indicate a higher level of user interest in the content of the response, than a shorter duration spent on the electronic document. As another example, a longer duration spent watching a video of the response can indicate a higher level of user interest in the content of the response, than a shorter duration spent watching the video.

In some implementations, the user substate for the user 244 can further be based on contextual information about the user. For example, contextual information about the user can include information about the user, the user session, or of a particular user interaction. For example, contextual information can include a location of the client device during the user session, a type of the client device, or a time of day or a time of year of the user session or of a particular user interaction, etc.

In some implementations, the user substate for the user 244 can further be based on information related to one or more previous user sessions of the user with the AI system 160. For example, the user substate for the user 244 can be based on the user's interactions in previous user sessions. The user substate for the user 244 can also be based on contextual information related to the previous user sessions. The user substate for the user 244 can include a categorization of the user's intent. For example, a substate for the user 244 can indicate the user is in an early exploration phase. A different substate for the user can indicate that the user is purchasing a product. Another substate for the user can indicate the user is comparing products.

In some implementations, the state record 240 can further include data representing a digital component provider substate for a digital component provider. For example, the digital component provider substate for the digital component provider 260 can represent information about the inventory of products or the goals/strategy of the digital component provider 260. The goals/strategy of the digital component provider can include a number of sales, or a level of risk the digital component provider is willing to accept. The digital component provider substate of the digital component provider 260 can indicate that the digital component provider 260 has a certain number of sneakers, basketballs, and sports jerseys. The digital component provider substate of the digital component provider 260 can also indicate that the digital component provider 260 would like to sell more sneakers.

In some implementations, the state record 244 can further include data representing a distribution plan substate that represents a distribution plan of the digital component provider for the digital component group of the digital component provider. In the example above, the distribution plan substate may indicate that the digital component provider 260 has a certain amount of resources available for distributing digital components related to sneakers, a certain amount of resources available for distributing digital components related to basketballs, and a certain amount of resources available for distributing digital components related to sports jerseys. The distribution plan substate can also represent the rate of consumption of the distribution plan, a categorization of the remaining amount of resources available, or a total amount of resources available.

In some implementations, the state record 240 can further include data representing a market substate determined based on present contextual information related to an environment in which the user session is occurring. For example, the present contextual information related to an environment in which the user session is occurring can include information about seasonality, trends, supply chain, and product. For example, the substate can represent that a major basketball tournament is occurring near the location of the user device and around the time of the user session. The substate can also represent that high-top sneakers are trending. The substate can also represent that there are no major supply chain disruptions between a warehouse storing the sneakers, basketballs, and sports jerseys and the location of the user device.

In some implementations, the state record 240 for a user can be maintained across multiple user sessions of the user. The AI system 160 can update the state record 240 for the user during each of the user sessions of the user. For example, the AI system 160 can store data representing the state record 240 in a database of state records. When a user begins a new user session, the AI system 160 can identify in the database whether the user has an existing state record 240. The AI system 160 can access the state record 240 and update the state record 240 for the user. If the user does not have an existing state record 240, the AI system 160 can create a state record 240 for the user and store data representing the state record 240 in the database.

In some examples, the output 232 can indicate that the data of an existing state record 240 should be updated. For example, the existing state record 240 can have been output from the language model 230 during a previous user session, or in response to a previous query in a current user session. The output 232 can include updates to the substate for the user 244, for example, based on new user interactions. The output 232 can also include updates to the substate of the digital component provider 260, the substate of a distribution plan, and the substate determined based on present contextual information related to the environment in which the user session is occurring.

In some implementations, the AI system 160 can update the state record 240 upon receiving a new user interaction 202. In some implementations, the AI system 160 can update the state record 240 multiple times for every new user interaction 202.

In some implementations, the AI system 160 can update the state record 240 upon receiving new information about the digital component provider 260, new information about the distribution plan, or new present contextual information related to the environment. For example, the AI system 160 may update the substates of the state record 240 based on new information about the digital component provider 260, or new contextual information related to an environment in which the user session is occurring.

In some implementations, the AI system 160 can update the substates of the state record 240 at different predetermined intervals. For example, the AI system 160 can update the substate for the distribution plan upon receiving new information about the distribution plan. The AI system 160 can update the user substate for the user upon receiving a new user interaction. The AI system 160 can update the digital component provider substate for the digital component provider at a longer interval, for example, once a day.

The trajectory apparatus 250 can generate potential trajectories 248 based on the state record 240. For example, the trajectory apparatus 250 can include a machine learning model, e.g., language model 170, that has been trained to generate potential trajectories 248 given the state record 240. The machine learning model can have been trained to generate predicted states, and, for each state, a utility and/likelihood of reaching the state during the current user session or a subsequent user session of the user.

The machine learning model can also have been trained to generate potential actions associated with each state and/or substate changes. For example, the machine learning model can have been trained to generate potential responses that are likely to lead to the associated state. The machine learning model can also have been trained to generate a selection value for each digital component based on the trajectories and corresponding state information (e.g., states and utility and/or likelihood for each state).

In some examples, the machine learning model can have been trained to generate potential trajectories 248 given embeddings for the state record 240. For example, the trajectory apparatus 250 can generate embeddings for the state record 240. For example, the trajectory apparatus 250 can generate embeddings for each substate of the state record 240. The trajectory apparatus 250 can provide embeddings for the state record 240 to the machine learning model trained to generate predicted states, utilities, and likelihoods.

In some implementations, the trajectory apparatus 250 can generate embeddings for each substate at different intervals. For example, the trajectory apparatus 250 can generate embeddings for the substate for the distribution plan whenever the prompt apparatus 220 receives new user session data 212. The trajectory apparatus 250 may not generate embeddings for the substate for the digital component provider whenever the prompt apparatus 220 receives new user session data 212. For example, the trajectory apparatus 250 can generate embeddings for the substate for the digital component provider at a predetermined interval of time, and use the same embeddings for the substate for the digital component provider for that interval of time. The AI system 160 can thus ensure that the trajectory apparatus 250 generates potential trajectories quickly and uses less computing resources than generating embeddings for all substates whenever the prompt apparatus 220 receives new user session data 212.

The trajectory apparatus 250 can be trained to generate one or more potential trajectories given an input that includes a state record 240. The trajectory apparatus 250 can be trained on training data that includes state records, actions such as user interactions and responses, and substate changes. The training data can also include responses that were shown to users, and with which responses the users interacted. In some implementations, the trajectory apparatus 250 can have been trained using reinforcement learning, for example. The trajectory apparatus 250 can have been trained to maximize utility for the user, the AI system 160, and/or a digital component provider.

In some implementations, the trajectory apparatus 250 can include multiple models. For example, the trajectory apparatus 250 can include a model that generates embeddings for substates, and another model that generates potential trajectories. The trajectory apparatus 250 can include another model that generates likelihoods and utilities for each state of the potential trajectories.

In some implementations, the trajectory apparatus 250 can include a language model. The AI system 160 can provide the state record 240 as input to the language model of the trajectory apparatus 250, and receive one or more potential trajectories 248 from the language model. For example, the AI system 160 can provide embeddings of the data of the state record 240 to the trajectory apparatus 250.

In some examples, the language model can be configured to receive the state record 240 as text and generate potential trajectories 248 in text. In some examples, the language model can be configured to receive the state record 240 as one or more tokens that represent the substates of the state record 240, and generate potential trajectories 248 that include states that are each represented by one or more tokens.

In some implementations, the trajectory apparatus 250 can include multiple models. For example, the trajectory apparatus 250 can include a language model that generates potential trajectories with states. The trajectory apparatus 250 can include another model that generates likelihoods and utilities for each state. The trajectory apparatus 250 can include another model that generates selection values for digital components based on the trajectories and/or state information.

A potential trajectory 248 can represent a transition from the state represented by the substates of the state record 240 to a different state. The potential trajectory 248 from the state of the state record 240 to a different state can include intermediate states. The different state can be a predicted future state. In some examples, each potential trajectory 248 can lead to a unique different state. In some examples, multiple potential trajectories 248 can lead to the same different state. For example, each potential trajectory 248 can include different numbers of actions and intermediate states, or different combinations of actions, and intermediate states.

The potential trajectory 248 can also include actions for one or more of the states. For example, for each state, the actions can include a user interaction within the conversational user interface or a user interaction with a resource of a digital component provider that is associated with the state. The actions can also include a potential response displayed within the conversational user interface that is associated with the state.

For example, any predicted future states such as the intermediate states or the different state can have one or more associated user interactions. Each user interaction can be a user interaction within the conversational user interface, or a user interaction with a resource of the digital component provider. For example, a resource of the digital component provider can be an electronic document associated with the digital component provider that allows a user to purchase an item. Each user interaction can be a predicted or potential user query or user interaction with a potential response of the potential trajectory 248.

In some implementations, the potential responses associated with each state can be potential responses that the trajectory apparatus 250 predicts are likely to lead to the state for the user. Each potential response can include a conversational response such as a natural language text relevant to a user query, for example. For example, the conversational response can include an open-ended question, or a question and a set of options for the user to select from. Each potential response can include, for example, a digital component. In some examples, each potential response can include natural language text relevant to a user prompt and a digital component. The trajectory apparatus 250 can generate digital components or select digital components by indexing into a digital component database.

The potential trajectory 248 can also include substate changes for one or more of the states. For example, the potential trajectory 248 can transition from a first state to a different state through a substate change. For example, the substate of the distribution plan of the first state may change, leading to the different state.

Each potential trajectory 248 can include a first state that is represented by the state record 240, a different state, and in some examples, one or more intermediate states.

The potential trajectory 248 can also include a utility and a likelihood for one or more of the states. For example, the utility can indicate an expected amount of progress toward a goal for a digital component provider 260, the user, for example. For example, if the goal of the digital component provider 260 is for a user to purchase a certain product, the utility for a state can indicate an amount of progress towards purchase that the state would provide and/or whether the purchase occurs in that state.

The likelihood can indicate a prediction of how likely the state is to occur. The likelihood of a state occurring after a period of time, or after multiple intermediate states, can be lower than the likelihood of a state occurring immediately after the state represented by the state record 240, for example. The likelihood can be based on the substates of the state record 240. For example, the utility can be higher when the substate determined based on present contextual information indicates that a major basketball tournament is occurring and users are likely to purchase jerseys to represent their team. The utility can be higher when the substate determined based on present contextual information indicates that basketball jerseys are fashionable and users are likely to purchase jerseys for everyday wear.

The utility for one or more states can be based on the state record 240. For example, the substate for the user 244 can represent a substate that is often a precursor to purchasing a product. The utility for the state can be higher than for another substate for the user that is more exploratory or does not lead to a purchase as often.

The utility can also be based on contextual information about the user. For example, the utility for state can be higher when the substate of the user indicates that the user is exploring basketball-related gifts and is interested in basketball.

The utility can also be based on information related to one or more previous user sessions of the user with the AI system 160. For example, the utility for the state can be higher when the substate for the user indicates that the user is exploring basketball-related gifts, and information related to previous user sessions of the user indicates that the user has previously purchased basketball-related products.

The utility can also be based on a substate of a digital component provider. For example, the utility for a state where the substate indicates that the user is exploring basketball-related gifts can be higher for a particular digital component provider when the particular digital component provider currently has an excess of inventory for basketballs. The utility can also be higher for a particular digital component provider when the particular digital component provider has goals for selling more basketball-related products.

The utility can also be based on information about a substate of a distribution plan for a digital component provider. For example, the utility can be higher for a particular digital component provider that has a larger amount allocated to basketball sneakers than to sports jerseys.

The utility can also be based on a substate determined based on present contextual information related to an environment in which the user session is occurring. For example, the utility can be higher when the present contextual information indicates that a major basketball tournament is occurring and basketball is a popular sport. The utility can be higher when the present contextual information indicates that basketball jerseys are fashionable. The utility can be higher when the present contextual information indicates that there are no major supply chain disruptions between a warehouse storing the basketball jerseys and the location of the user device, and the user can quickly receive a jersey that they purchase.

In some implementations, the potential trajectories 248 can represent a distribution of outcomes. The potential trajectories 248 can also include uncertainty information for each of the user states.

In some implementations, the potential trajectories 248 can represent trajectories that transition to a goal state. For example, data representing the goal state can be included in the input prompt to the language model of the trajectory apparatus 250 so that the language model generates potential responses that are associated with the goal state. For example, the language model can generate potential responses that are likely to lead to user interactions that are associated with the goal state. In some implementations, the potential trajectory can include a utility and a likelihood for one or more states, and the AI system 160 can obtain a respective selection value for each of the states from each of the digital component providers. In these implementations, the language model can generate responses after obtaining selection values for potential responses from digital component providers. For example, the language model can generate a response for the digital component provider that provided the highest selection value. For example, the response can include a digital component provided by the digital component provider that provided the highest selection value.

The AI system 160 can obtain a respective selection value 262 for each of the states for each of the potential trajectories 248. For example, the AI system can obtain the respective selection values 262 from the digital component provider 260. For example, the AI system can provide the potential trajectories 248 to the digital component provider 260. The AI system 160 can receive a selection value 262 for each of the states for each of the potential trajectories 248 from the digital component provider 260. A selection value can represent the amount that a digital component provider 260 is willing to provide to a publisher for presenting the digital component.

In some implementations, the AI system 160 of FIG. 1 can provide recommendations for digital component providers. For example, the AI system 160 may determine that the distribution plan for a first digital component provider is not performing well. The AI system 160 may recommend that the first digital component provider provide a higher selection value for a state with higher likelihood than for a second digital component provider whose distribution plan is performing well. As another example, the AI system 160 may determine that the distribution plan for the second digital component provider is performing well. The AI system 160 may recommend that the second digital component provider provide a higher selection value for a state with lower likelihood but higher utility than for the first digital component provider whose distribution plan is not performing well.

In some examples, the selection values 262 can be based on the utility and likelihood of the states of the potential trajectories 248. In some implementations where the potential trajectories 248 include uncertainty information, the selection values 248 can also be based on the uncertainty information.

The AI system 160 can display one or more responses in the conversational user interface based at least in part on the selection values 262. For example, the AI system 160 can provide the potential trajectories 248 and the selection values 262 to the response apparatus 250. A higher selection value 262 for a state can indicate a higher interest from the digital component provider 260 in the state. The response apparatus 250 can select a response 252 from the potential responses for display in the conversational user interface. In some implementations, the selected potential response that is displayed as response 252 can include a digital component 254. For example, the response apparatus 250 can include a digital component 254 from a digital component provider 260 that set a highest selection value 262 for the state for the user associated with the response 252.

In some examples, the response apparatus 250 can select a potential response of a potential trajectory 248. The selected potential response can be associated with a state that has the highest selection value of all of the states of the potential trajectories 248, for example. The AI system 160 can display the selected potential response as response 252 in the conversational user interface.

In some examples, the response apparatus 250 can select a potential trajectory 248 that has a highest combination of selection values 262 for its states. The states for the user in the potential trajectory 248 can have the highest combination of selection values 262 of all of the potential trajectories 248, for example. The AI system 160 can display a potential response associated with a first state of the selected potential trajectory as response 252 in the conversational user interface.

After displaying the response 252 in the conversational user interface, the AI system 160 can receive data indicating one or more user interactions by the user for the response 252. The AI system 160 can update the state record 240 based on the one or more user interactions for the response 252.

The AI system 160 can continue updating the state record 240 during the user session based on user interactions with responses 252. For example, the AI system 160 can use the conversational user interface to detect user interactions indicative of whether the user interacted with the displayed responses 252, and update the state record 240 as described above.

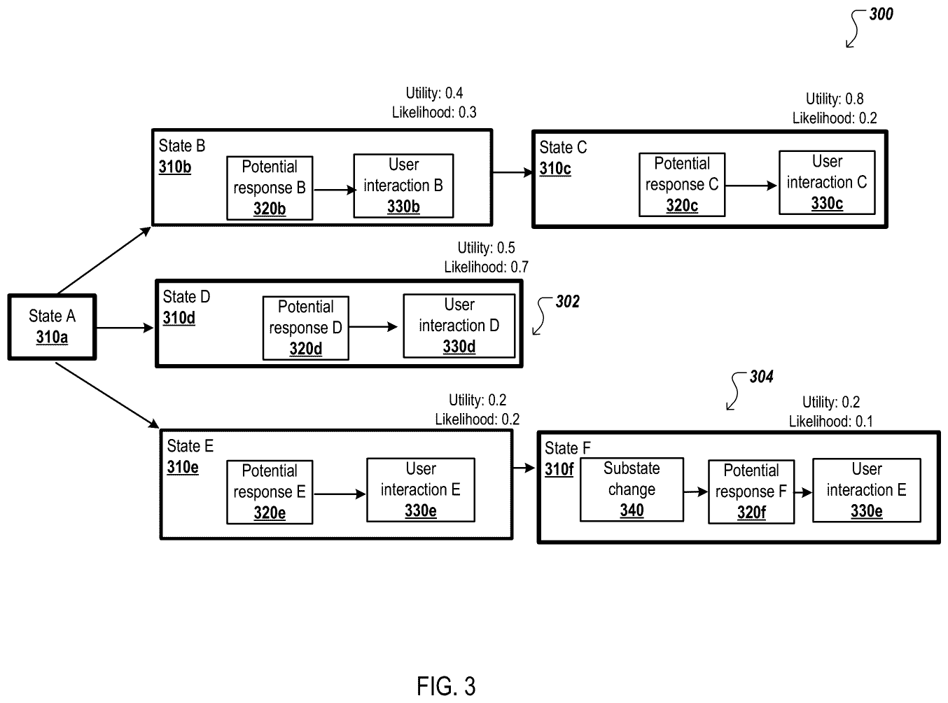

FIG. 3 depicts example potential trajectories 300, 302, and 304. Each potential trajectory represents a transition through a first state, state A 310a, and a different state than state A 310a, such as state C 310c or state F 310f. For example, the state A 310a can include a substate for the user that indicates the user is exploring options for a gift for a sports fan. In some examples, each potential trajectory can include one or more intermediate states such as state B 310b, state E 310e, or state G 310g.

The example potential trajectories 300, 302, and 304 also include one or more actions that are associated with each state 320. The actions can include potential responses 320, and user interactions 330 within the conversational user interface or with a resource of a digital component provider. The user interactions 330 can be predicted or potential user interactions with potential responses 320.

The example potential trajectory 300 represents a transition from state A 310a to state C 310c through the intermediate state B 310b. The state B 310b can represent a change in the substate for the user from state A. For example, the substate of the user for state B 310b can indicate that the user is exploring options for different categories of gifts. The state C 310c can represent a change in the substate for the user from state B. For example, the substate of the user for state C 310c can indicate that the user is choosing between configurations of one product, such as size and color.

The potential response B 320b can be a response that is associated with the state B 310b, or is predicted to lead to the state B 310b, which includes that substate for the user of exploring options for different categories of gifts. The potential response B 320b can include a natural language text query that asks about the recipient's favorite sports. For example, the potential response B 320b can include an open-ended question about the recipient's favorite sports. The potential response B 320b can also include options for the user to select to answer the question. The user interaction B 330b can indicate that the user answered “basketball,” or selected the option corresponding to “basketball.”

The potential response C 320c can be a response that is associated with the state C 310c, or is predicted to lead to the state C 310c, which is choosing between configurations of one product. The potential response C 320c can include a digital component for a pair of basketball sneakers, for example. The digital component can be provided by a particular digital component provider. The AI system 160 can select the digital component to display based on the selection values provided by one or more digital component providers. For example, each digital component provider can provide a different selection value for displaying a digital component for one of their products. The AI system 160 can select the digital component with the highest selection value. The user action C 330c can indicate that the user clicked on the link to the resource of the particular digital component provider for the basketball sneakers.

The example potential trajectory 302 represents a transition from state A 310a to state D 310d. The state D 310d can indicate that the user is choosing between configurations of one product, such as size and color.

The potential response D 320d can be a response that is associated with the state C 310c, or is predicted to lead to the state D 310d, which is choosing between configurations of one product. The potential response B 320b can include a digital component for a product related to sports, such as basketball sneakers. The digital component can be provided by a particular component provider. The AI system 160 can select the digital component to display based on the selection values provided by one or more digital component providers. For example, each digital component provider can provide a different selection value for displaying a digital component for one of their products. The AI system 160 can select the digital component with the highest selection value. The user action D 330d can indicate that the user clicked on the link to the resource of the digital component provider for the basketball sneakers.

Example values for utility and likelihood are also shown in FIG. 3. For example, the state B 310b has a utility of 0.4 and a likelihood of 0.3, and the state C 310c has a utility of 0.8 and a likelihood of 0.2. The state D 310d has a utility of 0.5 and a likelihood of 0.7. The AI system 160 described above can select one or more responses 320 to display based on selection values from one or more digital component providers. For example, a digital component provider may prefer a trajectory with a higher utility, that is, more likely to lead to a purchase event. The digital component provider may look beyond the immediate next state B 310b to the utility of state C 310c. The digital component provider may provide a higher selection value for state B 310b of the trajectory 300 than for the state D 310d of the trajectory 302, because the following state C 310c of the trajectory 300 has a utility. A second digital component provider may prefer a trajectory with higher likelihood. For example, the digital component provider may be more risk-averse than the digital component provider. The second digital component provider may provide a higher selection value for state D 310d of the trajectory 302 than for state B 310b of the trajectory 300, because although the utility of state D 310d of the trajectory 302 is lower than the state C 310c of the trajectory 300, the state D 310d has a higher likelihood than the state C 310c.

The example potential trajectory 304 represents a transition from state A 310a to state F 310f through the intermediate state E 310e. The state E 310e can indicate that the user is exploring options for different categories of gifts. The state F 310f can indicate that the user is purchasing a particular gift.

The potential response E 320e can be a response that is predicted to lead to the state E 310e, which is exploring options for different categories of gifts. The potential response E 320e can include a natural language text query that asks about the recipient's favorite sports. For example, the potential response E 320e can include an open-ended question about the recipient's favorite sports. The potential response E 320e can also include options for the user to select to answer the question. The user action E 330e can indicate that the user answered “basketball,” or selected the option corresponding to “basketball.” In some examples, the state E 310e can be associated with more than one potential response 320 and user action 330. For example, the state E 310e can be associated with multiple rounds of questions about the recipient's preferences, such as favorite sports teams, sizing, style, and color preferences.

The state E 310e can transition to state F 310f due to a substate change 340. For example, the substate determined based on present contextual information can change. For example, the substate may change due to the start of a popular basketball tournament. The substate for a distribution plan can also change. For example, the distribution plan can change to have a larger available amount. The potential response F 320f can be a response that is associated with the state F 310f. For example, the potential response can take into account the start of the basketball tournament, or the change in the distribution plan. The potential response F 320f can include a digital component for a pair of basketball sneakers, for example. The digital component can be provided by a particular digital component provider. The AI system 160 can select the digital component to display based on the selection values provided by one or more digital component providers. For example, each digital component provider can provide a different selection value for displaying a digital component for one of their products. The AI system 160 can select the digital component with the highest selection value. The user action F 330f can indicate that the user purchased the pair of basketball sneakers from the resource of the particular digital component provider for the basketball sneakers.

The state E 310e can have a utility of 0.2 and a likelihood of 0.2, for example. The state F 310f can have a utility of 0.2 and a likelihood of 0.1. A particular digital component provider may choose not to provide a selection value for state E 310e because it has a low utility and likelihood. A second digital component provider may choose to provide a high selection value for state E 310e because it is likely to lead to state F 310f, which has a high expected value.

In some examples, the state C 310c, state D 310d, or the state F 310f can be goal states. The potential responses 320 can be responses that are likely to lead to user interactions 330 that are associated with the goal state. For example, the potential responses 320 associated with the state C 310c can be responses that are likely to lead the user being in a state of choosing product configurations.

In some implementations, the potential trajectories can be updated after every user interaction 330, or at every update to the state record for the user. In some implementations, the potential trajectories can be updated after one or more substate changes.

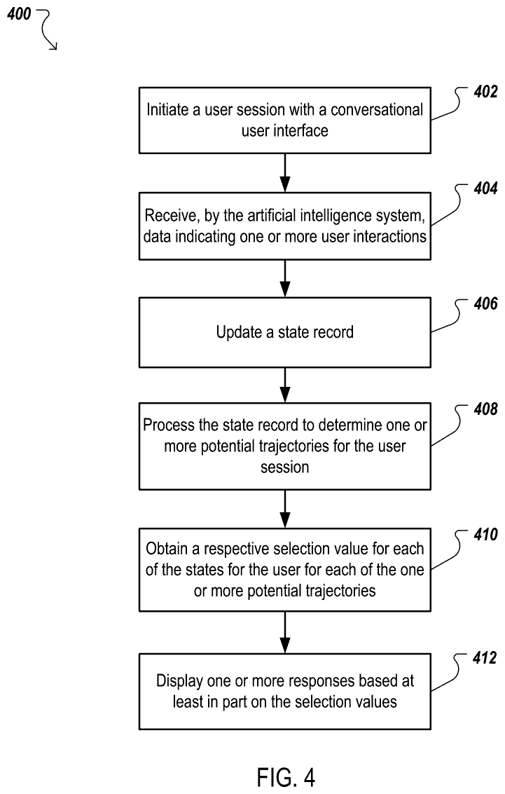

FIG. 4 is a flow chart of an example process 400 for generating and displaying responses in a conversational user interface based on a state record. Operations of the process 400 can be performed, for example, by the service apparatus 110 of FIG. 1, or another data processing apparatus. The operations of the process 400 can also be implemented as instructions stored on a computer readable medium, which can be non-transitory. Execution of the instructions, by one or more data processing apparatus, causes the one or more data processing apparatus to perform operations of the process 400.

A user session with a conversational user interface of an artificial intelligence system is initiated (402). The artificial intelligence system displays, within the conversational user interface, responses to user interactions received during the user session. The responses can be generated using one or more machine learning models of the artificial intelligence system.

During the user session, data indicating one or more user interactions are received by the artificial intelligence system (404). The user interactions can include user queries provided in the conversational user interface by a user. For example, the queries can include natural language text. The user interactions can also include actions such as clicks on responses or content of responses.

During the user session, a state record is updated (406). The state record represents a first state and includes at least data representing one or more substates. For example, the one or more substates can include a substate for the user. The substate for the user is determined by the one or more machine learning models based on the user interactions. The substate for the user can further be based on information related to one or more previous user sessions of the user with the artificial intelligence system. The substate for the user can further be based on contextual information about the user.

In some implementations, the state record can also include data representing a substate of a digital component provider. The state record can also include data representing a substate of a distribution plan. In some implementations, the state record also includes data representing a substate determined based on present contextual information related to an environment in which the user session is occurring.

In some implementations, the state record can be maintained across multiple user sessions for the user. The state record can be updated during each user session of the multiple user sessions.

In some implementations, data indicating one or more changes to the substate of the digital component provider or to the substate of the distribution plan can be received by the artificial intelligence system. The system can update the state record based on the data indicating one or more changes.

In some implementations, data indicating one or more changes to the substate determined based on present contextual information can be received by the artificial intelligence system. The system can update the state record based on the data indicating one or more changes.

During the user session, the state record is processed to determine one or more potential trajectories for the user session (408). Each potential trajectory represents a transition from the first state to a different state. Each potential trajectory can be determined by one or more machine learning models such as the one or more language models. For example, the state record can be included in one or more inputs to one or more machine learning models. The one or more potential trajectories can be received from one or more machine learning models. In some implementations, each potential trajectory can include a utility and a likelihood for each state.

In some examples, each potential trajectory can include one or more intermediate states. Each potential trajectory can include, for one or more states, one or more actions. The one or more actions can include a user interaction within the conversational user interface. The actions can also include a user interaction with a resource of a digital component provider. The actions can also include a potential response displayed within the conversational user interface. Each potential trajectory can also include, for one or more states, one or more substate changes.

In some implementations, the different state can be a goal state. Each potential trajectory can include a utility and likelihood for one or more of the states. In these implementations, data representing the goal state can be included as an input prompt to the one or more machine learning models that generate potential trajectories, so that the one or more machine learning models generate potential responses that are likely to lead to user actions that are associated with the goal state.

During the user session, a respective selection value for each of the states for the user for each of the potential trajectories is obtained (410). For example, selection values can be obtained from multiple digital component providers. For example, a respective selection value for each of the states in each potential trajectory can be obtained from each of the multiple digital component providers.

During the user session, one or more responses is displayed based at least in part on the selection values (412). The one or more responses can include one or more digital components, for example.

In some implementations, a state of a potential trajectory that has the highest selection value among the states for all of the potential trajectories can be selected. A potential response associated with the selected state can be obtained. The potential response can be displayed in the conversational user interface.

In some implementations, a potential trajectory can be selected. The selected potential trajectory can have the highest combination of selection values for the states among the potential trajectories. A potential response associated with the first state of the selected potential trajectory can be obtained. The potential response can be displayed in the conversational user interface.

In some implementations, after displaying one or more responses, data indicating one or more interactions by the user can be received. The state record can be updated based on the one or more user interactions for each response.

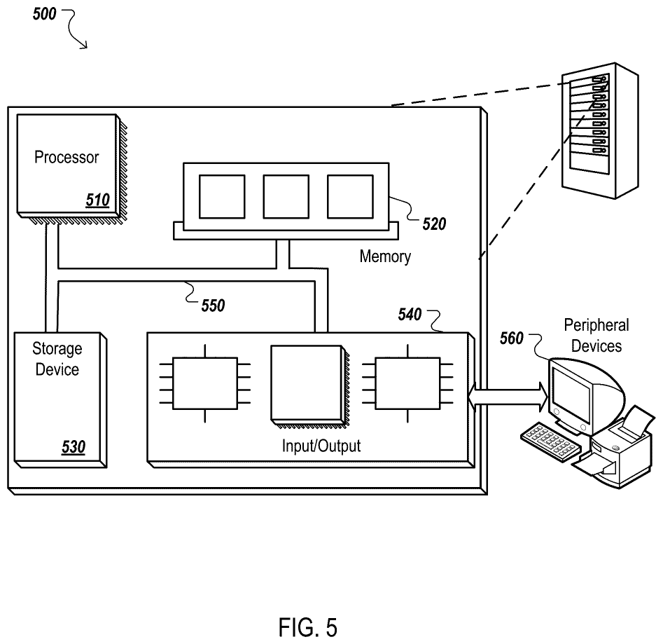

FIG. 5 is a block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
initiating a user session with a conversational user interface of an artificial intelligence system that displays, within the conversational user interface, responses to user interactions received during the user session, the responses being generated using one or more machine learning models of the artificial intelligence system; and
during the user session:
receiving, by the artificial intelligence system, data indicating one or more user interactions within the conversational user interface by a user;
updating, by the artificial intelligence system, a state record that represents a first state, comprising data representing one or more substates, and wherein the one or more substates comprise a substate for the user, wherein the substate for the user is determined by the one or more machine learning models based on the one or more user interactions;
processing, by the artificial intelligence system, the state record to determine one or more potential trajectories for the user session, wherein each potential trajectory represents a transition from the first state to a different state;
obtaining, by the artificial intelligence system and for each of the one or more potential trajectories, a respective selection value for each of the states for the potential trajectory; and
displaying, in the conversational user interface, one or more responses based at least in part on the respective selection values.

2. The method of claim 1, wherein the one or more user interactions comprise user queries provided by the user.

3. The method of claim 1, wherein the substate for the user is further based on any one or more of: information related to one or more previous user sessions for the user with the artificial intelligence system, or contextual information about the user.

4. The method of claim 1, wherein the state record further includes any one or more of: data representing a substate of a digital component provider, or data representing a substate of a distribution plan.

5. The method of claim 4, wherein the method further comprises:
receiving, by the artificial intelligence system, data indicating one or more changes to the substate of the digital component provider or to the substate of the distribution plan; and
updating, by the artificial intelligence system, the state record based on the data indicating one or more changes.

6. The method of claim 1, wherein the state record further includes data representing a substate determined based on present contextual information related to an environment in which the user session is occurring.

7. The method of claim 1, wherein the method further comprises:
receiving, by the artificial intelligence system, data indicating one or more changes to the substate determined based on present contextual information; and
updating, by the artificial intelligence system, the state record based on the data indicating one or more changes.

8. The method of claim 1, wherein the state record is maintained across a plurality of user sessions for the user, and wherein the state record is updated during each user session of the plurality of user sessions.

9. The method of claim 1, wherein processing the state record to determine one or more potential trajectories for the user session comprises:
including the state record in one or more inputs to one or more machine learning models; and
receiving one or more potential trajectories from one or more machine learning models.

10. The method of claim 1, wherein a potential trajectory of the one or more potential trajectories includes, for one or more states, one or more substate changes.

11. The method of claim 1, wherein a potential trajectory of the one or more potential trajectories includes, for one or more states, one or more actions.

12. The method of claim 11, wherein the one or more actions include any one or more of: a user interaction within the conversational user interface, a user interaction with a resource of a digital component provider, or a potential response displayed within the conversational user interface.

13. The method of claim 1, wherein each potential trajectory of the one or more potential trajectories includes a utility and a likelihood for one or more of the states.

14. The method of claim 1, wherein the different state is a goal state, and each potential trajectory of the one or more potential trajectories includes a utility and a likelihood for one or more of the states.

15. The method of claim 14, wherein data representing the goal state is included as an input prompt to the one or more machine learning models so that the one or more machine learning models generate potential responses that are associated with the goal state.

16. The method of claim 1, wherein obtaining a respective selection value for each of the states comprises obtaining a respective selection value for each of the states in each potential trajectory from each of a plurality of digital component providers.

17. The method of claim 16, wherein displaying one or more responses based at least in part on the respective selection values comprises:
selecting a state that has a highest respective selection value;
obtaining a potential response associated with the selected state; and
displaying the potential response in the conversational user interface.

18. The method of claim 17, wherein displaying one or more responses based at least in part on the respective selection values comprises:
selecting a potential trajectory that has a highest combination of respective selection values for the states of the potential trajectory;
obtaining a potential response associated with a first state of the selected potential trajectory; and
displaying the potential response in the conversational user interface.

19. A system comprising:
one or more processors; and
one or more storage devices storing instructions that, when executed by the one or more processors, cause the one or more processors to perform operations comprising;
initiating a user session with a conversational user interface of an artificial intelligence system that displays, within the conversational user interface, responses to user interactions received during the user session, the responses being generated using one or more machine learning models of the artificial intelligence system; and
during the user session:
receiving, by the artificial intelligence system, data indicating one or more user interactions within the conversational user interface by a user;
updating, by the artificial intelligence system, a state record that represents a first state, comprising data representing one or more substates, and wherein the one or more substates comprise a substate for the user, wherein the substate for the user is determined by the one or more machine learning models based on the one or more user interactions;
processing, by the artificial intelligence system, the state record to determine one or more potential trajectories for the user session, wherein each potential trajectory represents a transition from the first state to a different state;
obtaining, by the artificial intelligence system and for each of the one or more potential trajectories, a respective selection value for each of the states for the potential trajectory; and
displaying, in the conversational user interface, one or more responses based at least in part on the respective selection values.

20. A non-transitory computer readable storage medium carrying instructions that, when executed by one or more processors, cause the one or more processors to perform operations comprising:
initiating a user session with a conversational user interface of an artificial intelligence system that displays, within the conversational user interface, responses to user interactions received during the user session, the responses being generated using one or more machine learning models of the artificial intelligence system; and
during the user session:
receiving, by the artificial intelligence system, data indicating one or more user interactions within the conversational user interface by a user;
updating, by the artificial intelligence system, a state record that represents a first state, comprising data representing one or more substates, and wherein the one or more substates comprise a substate for the user, wherein the substate for the user is determined by the one or more machine learning models based on the one or more user interactions;
processing, by the artificial intelligence system, the state record to determine one or more potential trajectories for the user session, wherein each potential trajectory represents a transition from the first state to a different state;
obtaining, by the artificial intelligence system and for each of the one or more potential trajectories, a respective selection value for each of the states for the potential trajectory; and
displaying, in the conversational user interface, one or more responses based at least in part on the respective selection values.
